(19) United States
(12) Patent Application Publication
(10) Pub. No.: US 2011/0277946 A1
(43) Pub. Date: Nov. 17, 2011

(54) METHOD FOR LOCATING A CONTROL UNIT FOR CONTROLLING AN ACTUATOR FOR OPERATING A WINDOW COVERING ELEMENT

(75) Inventor: Eric Cheron, Taninges (FR)

(73) Assignee: Somfy SAS, Cluses (FR)

(21) Appl. No.: 13/102,609

(22) Filed: May 6, 2011

(30) Foreign Application Priority Data
May 12, 2010 (FR) 10/53731

(51) Int. Cl. G08B 1/08; A47H 5/02

(52) U.S. Cl. 160/340; 340/8.1

(57) ABSTRACT

Method for locating a first control unit (4) for controlling an actuator (2) for operating a window covering element (1). The method comprises, following a step for detecting the presence of a user, a step for activating a location means (7) for locating the first control unit.

This application claims priority benefits to French Patent Application Number 10 53731 filed May 12, 2010, the disclosure of which is incorporated herein by reference.

The invention relates to a control system for a motorized window covering element, such as a motorized curtain or venetian blind, for example intended to be installed in a hotel bedroom or in any room of a building in which a user finds on his own the equipment placed at his disposal, for example a conference room.

In a hotel bedroom, while the bedroom is unoccupied by a new user or when the latter is absent, the lights are switched off and the air conditioning is turned down, in order to save energy. Many documents of the prior art, such as U.S. Pat. No. 4,319,712, U.S. Pat. No. 4,223,301 or U.S. Pat. No. 5,620,137 describe this situation.

An action of the user on the lock of the hotel bedroom or of placing a card in a medium, places the bedroom in a welcome mode (switching on the lights, activating the electric plugs, adjusting the air conditioning) while a reverse action places the bedroom in an energy-saving mode.

In order to provide a better welcome for the user, it is possible to provide in addition a personalized lighting management scenario as described in patent application WO2008/032237.

However, for the same energy-saving reasons and to protect the internal decoration from ultraviolet rays, a motorized curtain is advantageously deployed automatically when the user is out of the bedroom and while the bedroom is unoccupied by a new user. If the latter arrives in daytime, one of his first actions will be to seek to open the curtain. Although there are conventions or customs relating to the location of the control units for controlling lighting (bed head, entrance of the bathroom, etc.), this is not the case for the control units for controlling a motorized curtain, whether these control units be of the fixed or mobile type.

Locating the control unit for controlling a motorized curtain therefore poses a problem which has made some manufacturers of curtain motorization devices provide an operating mode in the situation in which the user seeks to draw the curtain himself, through ignorance of the existence of a control unit. For example, Patent JP 3 368 606 describes a device for detecting a manual pull of the user on the curtain. This pull being detected, the motor of the motorized curtain automatically starts and completes the operation begun by the user.

Many documents such as U.S. Pat. No. 7,436,460 moreover describe means for locating mobile remote controls for television sets comprising a search activator placed on the television set and a location signal (sound- or light-based) generator placed on the mobile remote control. The same applies, for example, for finding a portable telephone handset from the portable telephone base. The handset is provided with a location signal generator while the base is provided with a search activator, for example a button connected to the transmission circuit of the base. In each case, the user acts on the search activator to find the mobile object.

These documents assume the existence of an object that is known and already located (the television set, the telephone base, etc.) on which the user distinguishes without ambiguity the means for activating a search, while, in the case of the motorized curtain, there is no such object or the latter, if it is the motor, is carefully hidden and difficult to reach.

Document U.S. 2002/93297 discloses a motorized awning system.

Document EP 1 213 692 discloses a method for allowing a user to get acquainted with the device equipping an office.

The documents of the prior art do not make it possible to solve in a simple and intuitive manner the problem of locating a control unit (or remote control unit) for controlling a motorized curtain.

The object of the invention is to provide a control system remedying the above drawbacks and improving the control systems known from the prior art. In particular, the invention provides a simple and intuitive control system making it possible to solve the problem of locating a control unit for controlling a motorized window covering element in an unknown environment. The invention further relates to a location method applied by such a control system.

According to the invention, the method makes it possible to locate a first control unit for controlling an actuator for operating or manoeuvring a window covering element. The method comprises, following a step for detecting the presence of a user, a step for activating a means for locating the first control unit.

The step for detecting the presence of the user may comprise a step for detecting an action of the user on the covering element, for example an open or close manual action of the user on the covering element.

The step for activating the means for locating the control unit may take place during a motorized movement of the covering element. This movement may follow the step for detecting the presence of the user.

The motorized movement of the covering element may be controlled by a second control unit.

The motorized movement of the covering element may be a step of a scenario executed automatically.

The motorized movement may be activated on expiry of a first time-out triggered by the step for detecting the presence of the user.

The location means may be deactivated on expiry of a second time-out.

The system according to the invention controls a window covering element. It comprises an actuator for operating the covering element and a control unit for controlling the actuator. It also comprises hardware and/or software means for applying the method defined above.

The hardware and/or software means for applying the method may comprise a means for locating the control unit and a means for detecting the presence of a user.

The means for detecting the presence may comprise a sensor for sensing presence and/or activity, possibly separated from the first control unit.

The sensor for sensing presence and/or activity may comprise a means for detecting a manual action of the user on the covering element.

The means for detecting a manual action may be activated by an action of pulling on the covering element.

The sensor for sensing presence and/or activity may comprise an RFID element.

The sensor for sensing presence and/or activity may comprise a sensor for sensing insertion of a card into a medium and/or a sensor for sensing operation of a door.

The sensor for sensing presence and/or activity may comprise an element of the volumetric type.

The window covering element may be a curtain.

The invention will be better understood on reading the following description given only as an example and made with reference to the appended drawings in which:

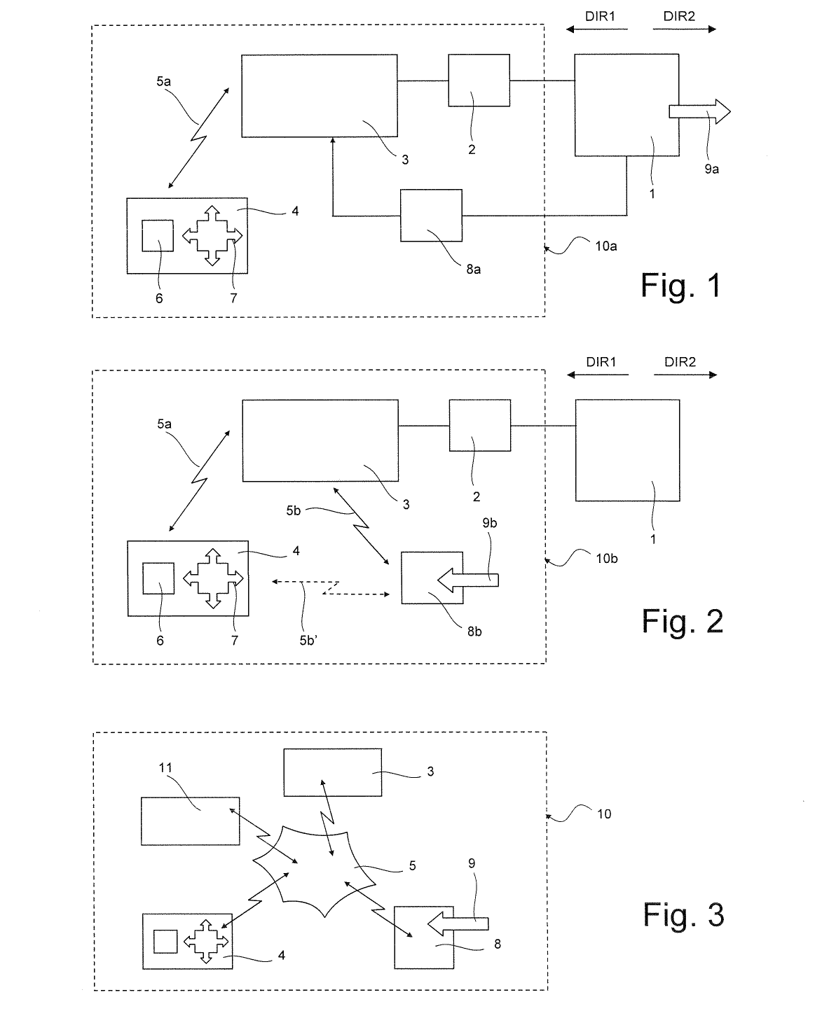

FIG. 1 is a diagram of a first embodiment of a control system according to the invention.

FIG. 2 is a diagram of a second embodiment of a control system according to the invention.

FIG. 3 is a diagram of a third embodiment of a control system according to the invention.

FIG. 1 describes a first embodiment of a control system 10a according to the invention. The control system comprises an actuator 2, such as a motor, connected to a window covering element 1 in order to drive the latter in an opening direction DIR1 or in a closing direction DIR2. The covering element may be any element of closure, of privacy, of solar protection or of screening. Described below is a curtain as a covering element. The motor is connected to a control means 3 controlling the power supply of the motor in a first or in a second direction or stopping it when a stopping condition is detected, for example when the curtain reaches an abutment.

The control system also comprises a remote control unit 4 comprising at least one control key 6 and communicating remotely with the control means via a first link 5a. Activating the control key causes the motorized movement of the curtain by the transmission of a command over the first link 5a, received and executed by the control means. As is known from the prior art, the command may be a command to change state (for example a 4-stage cycle (open-stop-close-stop) or may be a specific command (open-close-stop), if the remote control unit comprises several control keys, for example 3 control keys dedicated to each type of command.

The first link 5a is of the wireless type, preferably by radiofrequency waves or by infrared radiation. Alternatively, the first link 5a is of the wire type, for example by carrier currents superposed on the electricity network of the room.

The remote control unit also comprises a location means 7 such as a generator of a sensory signal, for example of the visual or audible type. This location means may consist of a light-emitting diode or of a set of light-emitting diodes, for example situated in the vicinity of the control key, and/or of a means for back-lighting the control key. Alternatively, or additionally, the location means may comprise a noise-maker, such as a buzzer. In all cases, the location means makes it possible to emit a sensory signal to the user of the room so that the latter unambiguously identifies the position of the control unit.

Alternatively, the control key is of the sensory type, touch-sensitive, on a screen of the tablet type. The location means then comprises for example a blinking of the back-lighting of the screen or an alternating change in the screen colours.

The control system finally comprises a sensor for sensing presence and/or activity, possibly separated from the remote control unit. In the first embodiment, this sensor is a means 8a for detecting a manual action on the curtain, for example an open or close manual action on the curtain. The sensor is connected both to the curtain and to the control means. When there is a pulling action 9a on the curtain, caused by the user, an item of information emitted by the sensor to the control means is used by the control means to power the motor in the direction of movement corresponding to the detected action.

In this case, the control means uses the first link 5a to cause the activation of the location means, on the remote control unit.

Therefore, the user causes the desired movement of the curtain, but he is notified at the same time of the location of the control unit, or even of the control key in question if a location means is associated with each control key of the control unit.

Therefore, without there being any need for additional explanations, the user understands that he can go straight to using the remote control unit for subsequent operations of the curtain, which, for him, is more comfortable and which prevents dirtying of the curtain due to a repetition of manual pulls.

FIG. 2 describes a second embodiment of a control system 10b according to the invention. The elements that are unchanged relative to the first embodiment are indicated by one and the same reference number and are not described again. The sensor for sensing presence and/or activity 8b is this time a sensor for sensing presence, capable of communicating an item of information concerning the presence of the user in the room. The sensor is for example of the volumetric type, and capable of detecting the bodily presence of the user of the room, or else of the RFID type and capable of detecting the presence of a badge worn by the user of the room or else of the type capable of detecting the insertion of a card in a card housing placed on a wall or table medium, or finally of the type capable of detecting the opening of a door.

The sensor is connected to the control means via a second link 5b, for example of the same type as the first link. When the sensor is activated by the presence 9b of the user, this item of information concerning the presence is transmitted to the control means which causes the execution of a motorized movement of the curtain, for example in a direction of opening of the curtain.

Thus, when the user enters the room, there is movement of the curtain. Simultaneously, the control means uses the first link 5a to cause the activation of the location means on the remote control unit.

Alternatively, the sensor is connected to the remote control unit via a third link 5b′, for example of the same type as the first link. The presence information is then used by the remote control unit to activate the location means and cause the transmission of a movement command over the first link.

Thus, this time the user causes indirectly, merely by his presence, the movement of the curtain, but he is at the same time notified of the location of the control unit. He intuitively associates the movement of the curtain with the control unit which will allow him, this time intentionally, to cause the movements of the curtain.

Many variants of this embodiment may be carried out. For example, it is possible to delay the motorized movement of the curtain relative to the activation of the location means.

Similarly, the duration of activation of the location means is limited. It may be shorter, or on the other hand longer than the duration of motorized movement of the curtain. For example, it may precede by 5 seconds the beginning of the motorized movement and continue 2 or 3 seconds after the end of the motorized movement.

FIG. 3 describes partially but more generally a third embodiment 10 capable of being adapted to several variant embodiments.

In this embodiment, the control means 3 and the remote control unit 4 communicate on one and the same home automation network 5 with other items of equipment. In particular, a sensor 8 for sensing presence and/or activity as described above also communicates over the home automation network. A supervision unit 11 also communicates over the home automation network. The information interchanges may take place between the elements of the home automation network and the supervision unit. Other sensors may then be associated with those described in the invention, for example one or more sunlight sensors, or else a clock.

Preferably, a motorized movement caused by a sensor for sensing presence takes place only when there is a first detection of presence and is repeated only when there is a change of identifier if the sensor for sensing presence is capable of recognizing an identifier (of the RFID type or of the code type on an access card).

Similarly, it is possible to make provision for the curtain to open only if it is daylight. In the case of a night arrival of the user, the control means keeps the curtain closed (unless there is action of the user on the control key) for example until it detects a double condition: both a movement condition (opening of a door for example, detection of movement) and a time condition (for example time later than 08:00).

Provision may also be made, notably during a night arrival, for a simple detection of presence to cause the activation of the location means, but without giving rise to a motorized movement of the curtain. In this case, the control unit preferably displays a clear instruction concerning its function. For example, the control buttons for the covering element are coated or associated with explicit pictograms. Alternatively, a pictogram representing a curtain appears on the control unit. There is then an implicit invitation to use the remote control unit, but it is only an encouragement, signified for a limited period by the activation of the location means. The commonplace use of control systems according to the invention will moreover have users getting used to associating the emission of a sensory signal by the location means with the “motorized curtain” function, thus making a motorized movement of the automatic curtain less and less necessary when there is a first detection of presence, except when this movement helps to exhibit a welcome sign for the attention of the user.

If the remote control unit and the supervision unit constitute a single element, for example in the form of a computer of the multiple-use tablet PC type, it is possible to make provision for a touch-sensitive screen of this computer to be capable of displaying a control icon (or control icons) for controlling the curtain, when the sensor for sensing presence or activity is activated, and capable of activating a signalling means as mentioned above (for example a blinking back-lighting if the finger has not touched the screen) in order to emit the sensory signal.

Many variants of the location method and the control system according to the invention may be carried out, in particular:
The movement of the covering element following a step for detecting the presence of a user may be controlled by another control unit such as a general control unit or a key medium such as a magnetic card medium. This other unit may comprise a welcome key controlling the execution of a scenario. The step for detecting the presence of a user may be performed by this other control unit. Alternatively, an item of information for detecting presence may be emitted in order to be received by this other control unit.
The detection of presence may be performed by a detection of proximity of a user, such as a detection of presence in the room comprising the covering element and/or the control unit 4.
The location means may be activated before the movement of the covering element, in particular before the beginning of the movement. Alternatively, the location means may be activated at the same time as the movement of the covering element. Again alternatively, the location means may be activated after the beginning of the movement of the covering element.
The movement of the covering element following a step for detecting the presence of a user may be an opening movement of the covering element.
The sensor for sensing presence and/or activity is preferably capable of communicating an item of information concerning presence to the control means for controlling the motor and/or to the remote control unit 4 and/or to another control unit, for example a supervision unit in communication with the control means for controlling the motor and/or with the remote control unit.
The sensor for sensing presence and/or activity preferably communicates with the supervision unit in order to transmit an item of information concerning presence and/or activity.

1. Method for locating a first control unit (4) for controlling an actuator (2) for operating a window covering element (1), wherein the method comprises, following a step for detecting the presence of a user, a step for activating a means (7) for locating the first control unit.

2. Location method according to claim 1, wherein the step for detecting the presence of the user comprises a step for detecting an open or close action of the user on the covering element.

3. Location method according to claim 1, wherein the step for activating the means for locating the control unit takes place during a motorized movement of the covering element, this movement following the step for detecting the presence of the user.

4. Location method according to claim 3, wherein the motorized movement of the covering element is controlled by a second control unit.

5. Location method according to claim 3, wherein the motorized movement of the covering element is a step of a scenario executed automatically.

6. Location method according to claim 3, wherein the motorized movement is activated on expiry of a first time-out triggered by the step for detecting the presence of the user.

7. Location method according to claim 3, wherein the location means is deactivated on expiry of a second time-out.

8. Control system (10, 10a, 10b) for controlling a window covering element (1), comprising an actuator (2) for operating the covering element and a control unit (4) for controlling the actuator, wherein the system comprises hardware and/or software means for applying the method according to one of the preceding claims.

9. Control system according to claim 8, wherein the hardware and/or software means for applying the method comprise a means (7) for locating the control unit and a means (8) for detecting the presence of a user.

10. Control system according to claim 9, wherein the means for detecting the presence comprises a sensor (8, 8a, 8b) for sensing presence and/or activity, possibly separated from the first control unit.

11. Control system according to claim 10, wherein the sensor for sensing presence and/or activity comprises a means (8a) for detecting an open or close manual action of the user on the covering element.

12. Control system according to claim 11, wherein the means for detecting a manual action can be activated by an action (9a) of pulling on the covering element.

13. Control system according to claim 10, wherein the sensor for sensing presence and/or activity comprises an RFID element.

14. Control system according to claim 10, wherein the sensor for sensing presence and/or activity comprises a sensor for sensing insertion of a card into a device and/or a sensor for sensing operation of a door.

15. Control system according to claim 10, wherein the sensor for sensing presence and/or activity comprises an element of the volumetric type.

16. Control system according to claim 8, wherein the window covering element is a curtain.
